(19) United States
(12) Patent Application Publication
(10) Pub. No.: US 2008/0148807 A1
(43) Pub. Date: Jun. 26, 2008

(54) DIFFERENTIAL PRESSURE SENSOR FOR FILTER MONITORING

(75) Inventors: Charles H. Berry, Cedar Falls, IA (US); Michael J. Lockert, Cedar Falls, IA (US)

Correspondence Address: SCHWEGMAN, LUNDBERG & WOESSNER, P.A., P.O. BOX 2938, MINNEAPOLIS, MN, 55402, US

(73) Assignee: Engineered Products Company, waterloo, IA (US)

(21) Appl. No.: 11/923,427

(22) Filed: Oct. 24, 2007

Related U.S. Application Data
(60) Provisional application No. 60/854,041, filed on Oct. 24, 2006.

(51) Int. Cl. G01L 27/00; G01L 9/14

(52) U.S. Cl. 73/1.57; 73/722

(57) ABSTRACT

The present inventors devised, among other things, exemplary differential pressure sensors suitable for use in a wide-variety filter-monitoring applications. One exemplary sensor, which operates in any physical orientation and consist of snap-together components that require no post-assembly adjustment, includes a diaphragm assembly, a magnet, and a magnetic sensor. The diaphragm moves in response to differential pressures exceeding a predetermined threshold difference, and the magnet which is physically coupled to the diaphragm assembly moves relative to a magnetic sensor. The magnetic sensor senses movement of the magnet and produces a signal that can be correlated by a computer or other circuitry to determine whether a filter is overly clogged and thus requires replacement.

### RELATED APPLICATION

The present application claims the benefit under 35 U.S.C.119(e) of U.S. Provisional Patent Application 60/854,041 which was filed on Oct. 24, 2006 and which is incorporated herein by reference.

### COPYRIGHT NOTICE AND PERMISSION

A portion of this patent document contains material subject to copyright protection. The copyright owner has no objection to the facsimile reproduction by anyone of the patent document or the patent disclosure, as it appears in the Patent and Trademark Office patent files or records, but otherwise reserves all copyrights whatsoever. The following notice applies to this document: Copyright ©2006 Engineered Products Company, Inc.

### TECHNICAL FIELD

Various embodiments of the present invention concern devices for monitoring fluid-filter performance, particularly devices that are responsive to differential pressures. Some embodiments of the invention may also be used in other applications.

### BACKGROUND

Many modern systems include filters to ensure proper or reliable performance. For example, automobiles and other vehicles include air or fuel filters to remove dirt and other particulates from the fuel that is ignited within their internal combustion engines. As a consequence of their proper operation, these filters collect particulates over time and increasingly restrict the flow of air and fuel into engines. Eventually, the filters become more restrictive than desirable and require replacement.

To facilitate timely filter replacement, automobiles and other systems sometimes include filter-monitoring devices, which monitor pressure or vacuum levels that result from fluid flow through associated filters. These devices are calibrated to detect when particular pressure or vacuum conditions occur and to respond to such occurrences in particular ways.

For example, some devices respond to the difference in pressure between the inlet and outlet of a fuel filter and provide a variable electrical resistance indicative of the differential pressure. This electrical resistance is typically wired to circuitry that can interpret a voltage related to the resistance as indicative or not indicative of an overly clogged filter and turn on a warning light or send a signal to an engine computer for further processing.

The present inventors have recognized that commercially available differential pressure sensors suffer several problems. For example, these differential sensors are generally too complex and costly to be used widely in many types of vehicles. They also recognized that the complexity of these sensors frequently resulted in less than desirable reliability, especially under extreme operating conditions. Moreover, the inventors recognized that many differential pressure sensors were limited to either horizontal or vertical orientations, which not only limited how vehicle manufacturers could design their fluid flow systems, but also limited the production volume of these sensors and ultimately increased their production cost.

Accordingly, the present inventors have recognized a need to improve conventional differential pressure sensors.

### SUMMARY

To address this and/or other needs, the present inventors devised, among other things, various embodiments of differential filter-monitoring devices and related components, subassemblies, methods, and systems. One exemplary low-cost differential filter-monitoring sensor includes a diaphragm that flexes in response to differential pressures across a filter, and thus moves a magnet within a guide sleeve. A hall-effect sensor adjacent the guide sleeve exhibits an electrical resistance based on location of the magnet in the guide sleeve, and circuitry coupled to the hall-effect sensor translates the electrical resistance into an electrical voltage. Among its many notable features, the exemplary embodiment provides a t

### BRIEF DESCRIPTION OF DRAWINGS

FIG. 1 is a block diagram of an exemplary engine system 100 which corresponds to one or more embodiments of the present invention.

FIG. 2 includes two perspective views of the differential pressure sensor in FIG. 1, each of which corresponds to one or more embodiments of the present invention.

FIG. 3 includes front, left, top, right, back and bottom views of the differential sensor of FIG. 1, each of which corresponds to one or more embodiments of the invention.

FIG. 4A is a center cross-sectional view of the differential sensor in FIG. 1, taken along line 4-4 in FIG. 3 and thus corresponds to one or more embodiments of the present invention.

FIG. 4B is an exploded cross-sectional view of the differential sensor in FIG. 1, based on FIG. 5 cross-section and corresponding to one or more embodiments of the present invention.

FIG. 4C is an exploded perspective view of an upper housing portion of the differential sensor shown in FIGS. 1-4B and which corresponds to one or more embodiments of the invention.

FIG. 4D is an exploded perspective view of the upper housing portion of the differential sensor shown in FIGS. 1-4B and which corresponds to one or more embodiments of the present invention.

FIG. 4E is a perspective view of a diaphragm subassembly within the differential sensor shown in FIGS. 1-4B and which corresponds to one or more embodiments of the present invention.

FIG. 5 is a center cross-sectional view of an exemplary differential sensor 500 corresponding to one or more embodiments of the present invention.

FIG. 6A is a perspective pie-sectional view of an exemplary differential sensor 600 which corresponds to one or more embodiments of the present invention.

FIG. 6B is a center cross-sectional view of differential sensor 600 which corresponds to one or more embodiments of the present invention.

FIG. 7 is a set of electrical schematics showing alternative wiring configurations for the differential sensor shown in FIGS. 1-4B.

### DESCRIPTION OF EXEMPLARY EMBODIMENT(S)

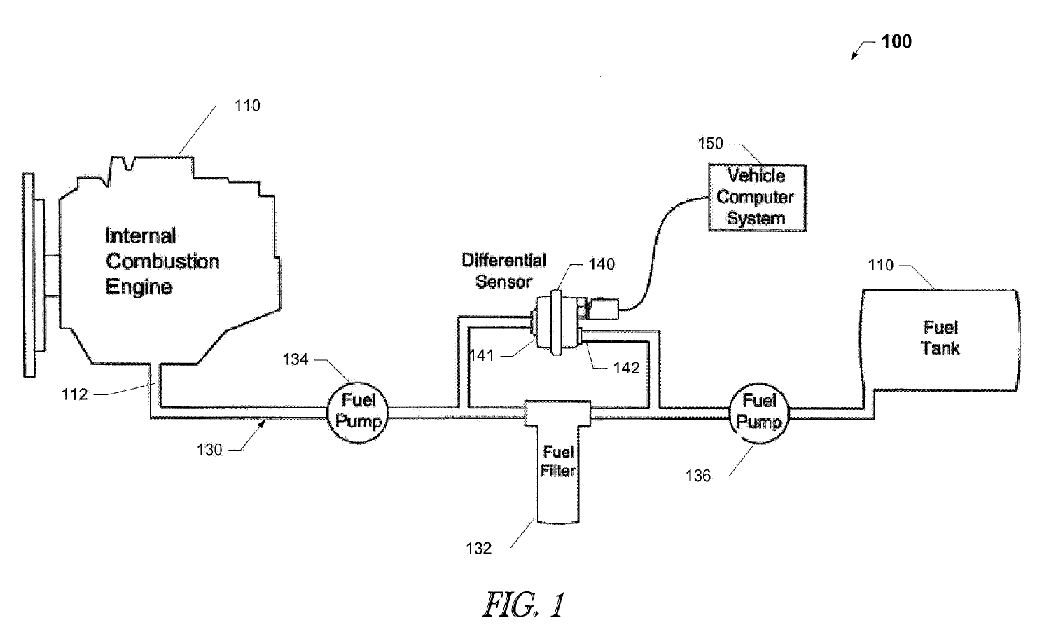

This description, which incorporates the above-identified figures and appended claims, describes one or more specific inventive embodiments. These embodiments, offered not to limit but only to exemplify and teach one or more inventions, are shown and described in sufficient detail to enable those skilled in the art to implement or practice the invention(s). The description may use terms, such as upper or lower in reference to specific features of various as embodiments; however, unless included in the claims, such terms are merely to aid correlating the drawings with the written description and thus promote understanding of the invention. Moreover, where appropriate to avoid obscuring the invention(s), the description may omit certain information known to those of skill in the art. FIG. 1 is a block diagram of an exemplary engine system 100.

FIG. 1 shows a block diagram of an exemplary engine system 100 which incorporates teachings of the present invention. System 100 includes an engine 110, a fuel tank 120, a fuel line 130, a differential sensor 140, and a vehicle computer system 150.

Engine 110 includes a fuel (or more generally fluid) inlet 112. In the exemplary embodiment, engine 110 is an internal combustion engine. Fluid inlet 112 is coupled to fuel tank 120 via fluid line 130.

Fluid line 130 includes a fuel filter 132 and fuel pumps 134 and 136. In the exemplary embodiment, fuel filter 132 and pumps 134 and 135 take any convenient or desirable form. Some embodiments omit one of the fuel pumps. Fuel filter 130 provides a filtered fuel flow from fuel tank 120 through pump 136, through filter 134, through fuel pump 134 to filter fuel inlet 112 into engine 110.

Coupled to fluid line 130 across the inlet and outlet of fuel filter 132 is differential sensor 140. Sensor 140 includes a low or negative pressure port 141, a high or positive pressure port 142, and a sensor-connector module 143. (The low and high pressure ports may also be referred to as inlet and outlet ports, respectively.) In the Figure, the sensor is shown in a horizontal orientation (based on the inlet and outlet ports), but its novel design allows it to operative effectively with a vertical, diagonal, and in fact any desirable orientation. The sensor, which in the exemplary embodiment is fully isolated from fluid line 130 and takes the form of a magnetic sensor, may be used with multiple types and makes of filters. Sensor-connector module 143 includes a connector in electrical communication with vehicle computer system 150, which may take any convenient or desirable form.

In the exemplary embodiment, differential sensor 140 has the following operating conditions:

TABLE 1
Exemplary Sensor Parameters

| | |
|---|---|
| Differential Pressure Operating | 50 psi |
| Conditions | |
| Operating Temperature | −40° C. to 121° C. |
| Fluid Compatibility | Automotive Fuels, Gasses, Oils |
| | Air and Exhaust Systems |
| Vibration Capable | 10-2000 Hz & 10 g's |
| Operating Environment | On & Off Highway |
| Resistance to all underhood | |
| chemicals | |
| Mounting Attitude | Can be mounted in any orientation |
| Mounting | Various custom fittings available |
| Electrical Connection | AMPSEAL 16 Sealed Connector |
| Cylindrical Space Requirements | 7.7 cubic inches (max. radius of |
| | sensor 0.98 in.; max length of 2.55 |
| | inches.) |

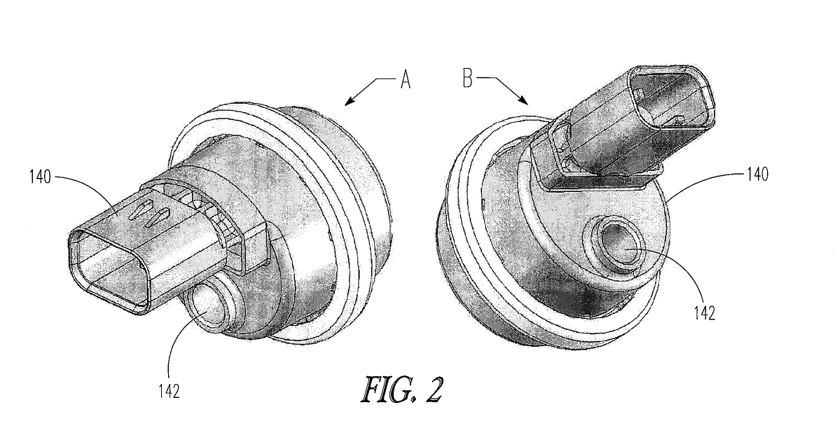

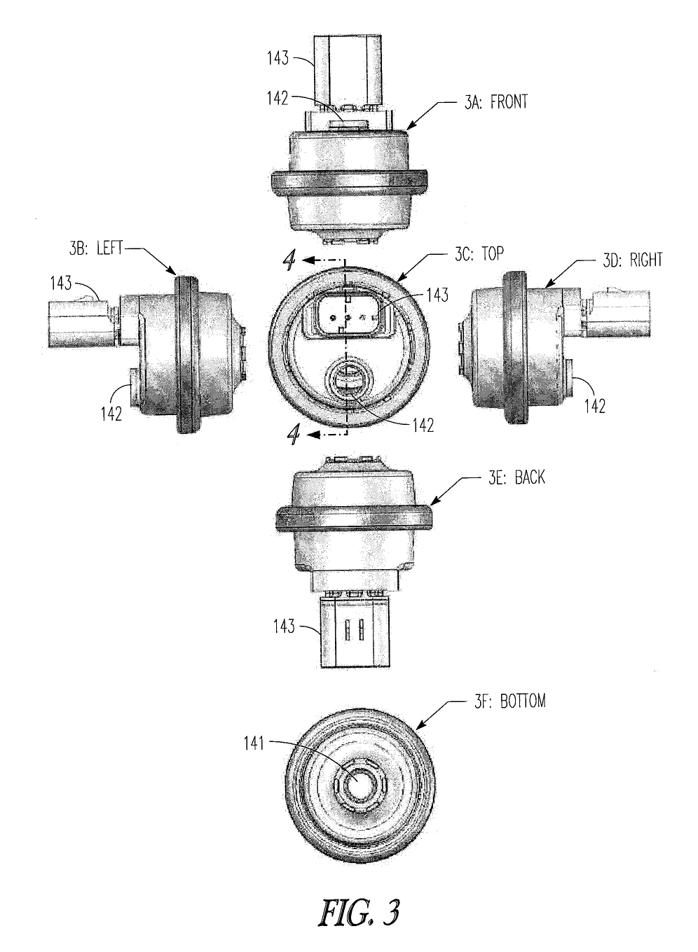

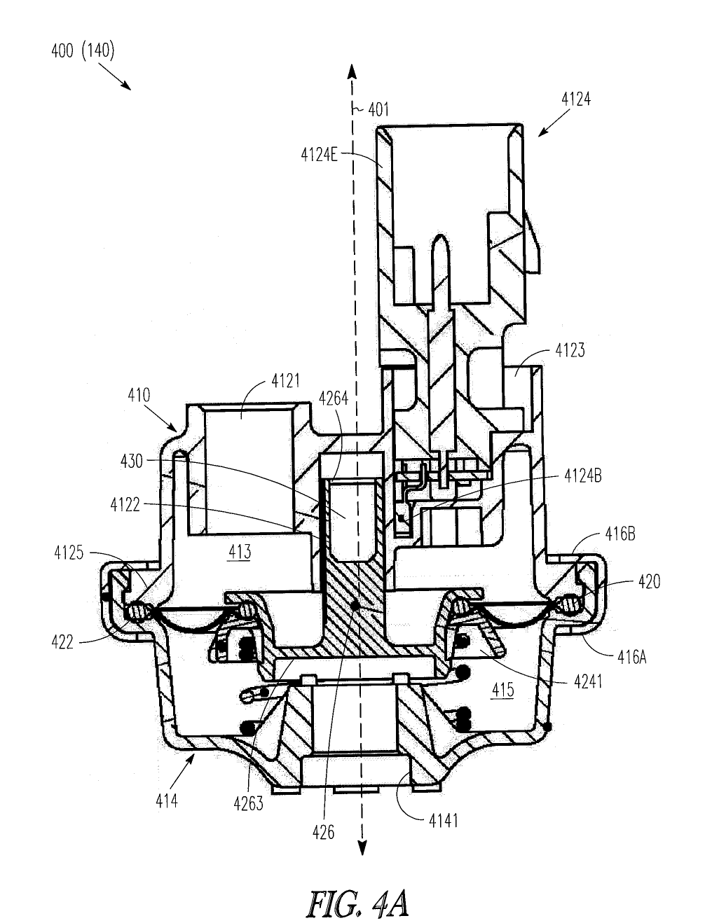

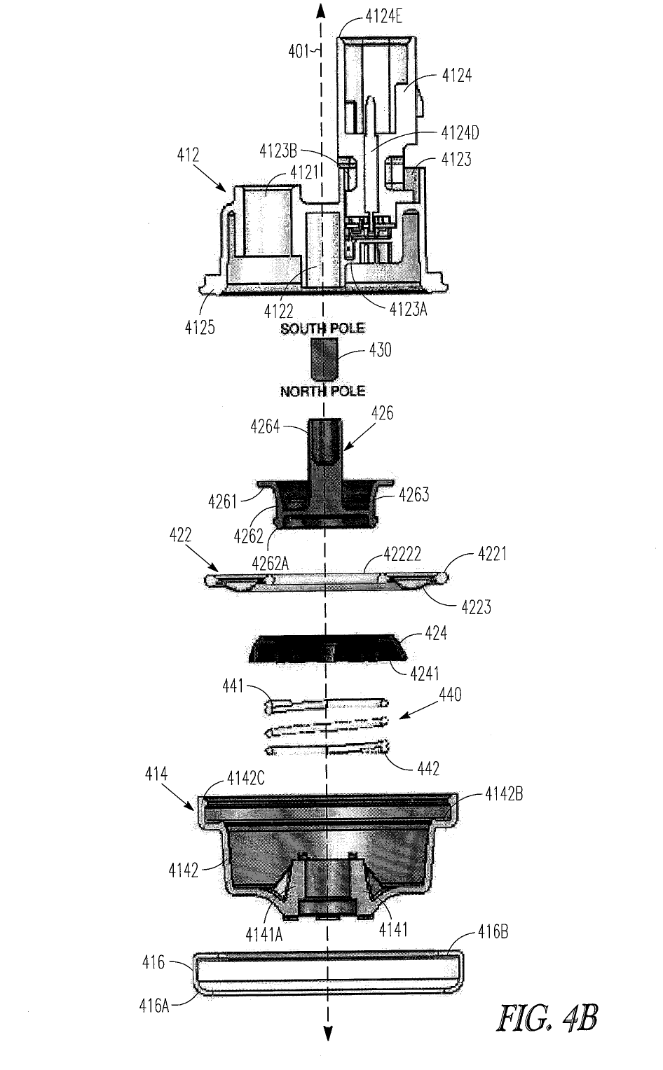

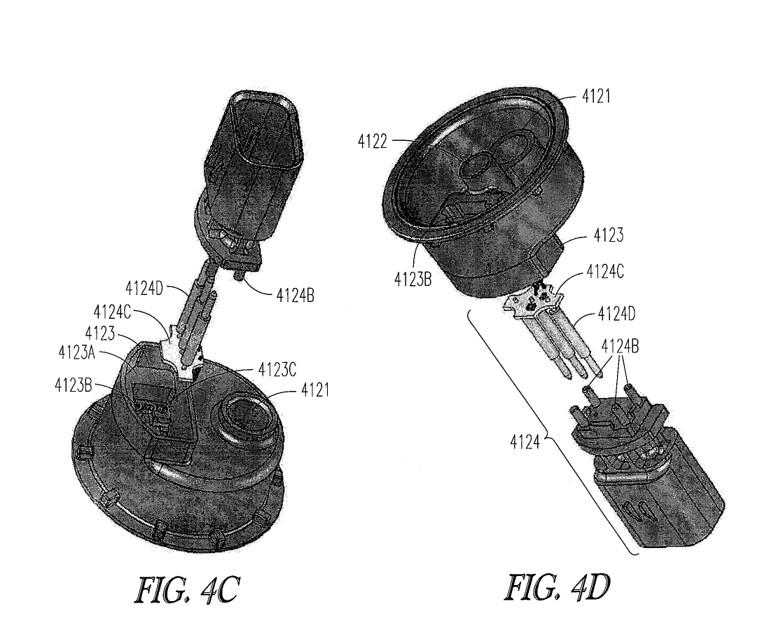

The exterior of sensor 140 is shown in perspective views A and B of FIG. 2. Front, left, top, right, back, and bottom views are shown in FIG. 3. FIGS. 4A and 4B show further structural detail of differential sensor 140 (400).

FIG. 4A is a center cross-section taken along line 4-4 in the top view of FIG. 3, and FIG. 4B is an exploded view of this same cross-section. Both Figures show that differential sensor 140 (400) includes a three-piece housing assembly 410, a three-piece diaphragm assembly 420, a magnet 430, and a calibration spring 440.

More particularly, three-piece housing assembly 410 includes an upper housing (cap) portion 412, a lower housing portion 414, and a retaining collar 416. Upper housing portion 412, which is generally horn-shaped in the exemplary embodiment, includes a high (positive) pressure port (or inlet) 4121, a guide sleeve 4122, a sensor-connector socket 4123, and a sensor-connector module 4124.

High pressure port 4121, which corresponds to port 142 in the prior figures, is integrally molded as part of an interior surface of upper housing portion 412. In the exemplary embodiment, port 4121 is generally a right cylindrical opening that is laterally offset from a central axis 401 of the sensor and includes internal threads to facilitate fluid-tight coupling to a fluid line or filter. Guide sleeve (or tube) 4121 is integrally molded as part of the interior surface of upper housing in coaxial alignment with central axis 401.

Guide sleeve 4122 is integrally molds as part of an interior surface of upper housing portion 412. In the exemplary embodiment, port 4121 is generally a right cylindrical tube or recess.

Sensor-connector socket 4123, shown in perspective in FIGS. 4C and 4D, includes a lower socket portion 4123A, and an upper socket portion 4123B. Upper socket portion 4123B includes alignment holes 4123C. Sensor-connector socket 4123 mates with sensor-connector module 4124.

Sensor-connector module 4124, which corresponds to sensor-connector module 143 in FIGS. 1-3 and is also shown in exploded perspective view of FIGS. 4C and 4D, includes a hall-effect sensor 4124A, alignment pins 4124B, a circuit board 4124C, connector pins 4124D, and a connector socket portion 4124E. Hall-effect sensor 4124A (or more generally any transducer that varies an electrical property in response to changes in a magnetic field, such as magnetic field intensity) mates with lower socket portion 4123 next to guide sleeve 4122. Alignment pins 4124B mate or engage with alignment holes 4123C to ensure proper positioning of the sensor relative to the guide sleeve (and the magnet described below). In the exemplary embodiment, the depth of the alignment holes and the length of the alignment pins are set to result in precision placement of the sensor within the lower socket portion and at the midpoint of the guide sleeve length.

Sensor 4124A has three leads (not visible in FIG. 4) that are through-hole mounted to circuit board 4124C and electrically connected to connector pins 4124D, with the sensor leads spacing the body of the hall-effect sensor below the lower surface of the circuit board. Connector pins 4124D, which are also through-hole mounted to circuit board 4124C, extend through holes in a bottom portion of connector socket 4124E to define a three-terminal connector, which in the exemplary embodiment are electrically coupled to vehicle computer system 150 (as shown in FIG. 1).

In the exemplary embodiment, sensor connector module 4124 is permanently mounted within sensor-connector socket 4123 using potting epoxy, thereby facilitating handling of the upper housing portion 412 as a single part during final assembly of the differential sensor. (The exemplary embodiment molds the majority of upper housing portion 412 from glass-filled Nylon 6/6.)

In addition to upper housing portion 412, housing assembly 412 includes lower housing portion 414 and retaining collar 416. More particularly, lower housing portion 414, which generally has a pan- or cup-like shape in the exemplary embodiment, includes a low pressure port (or inlet) 4141 and an outer sidewall 4142. Low pressure port 4141, which is formed as an interiorly threaded cylindrical tube concentric with axis 401 and guide sleeve 4122, includes a sidewall 4141A. In the exemplary embodiment, low pressure port 4141, which corresponds with port 141 in FIG. 1, is in fluid communication with a low pressure side of a fuel filter. Outer sidewall 4142, which is also concentric with axis 401, extends upward and outward from a lower portion of port 4141, terminating in an annular flange 4142A, which includes an annular ledge 4142B and a snap-lock rim 4142C.

The height of sidewall 4141A and outer sidewall 4142 are selected not only to permit movement of diaphragm 422, but also to prevent it from traveling too far during over-pressure situations. Lower housing portion 4142 engages with a lower flange portion 4125 of upper housing portion 412, for example via a snap fit.

Collar 416, which is formed of aluminum in the exemplary embodiment, encircles the interface between upper housing portion 412 and lower housing portion 414 to add further integrity and aesthetic appeal to the sensor. Collar 416 includes upper and lower rolled edges 416A and 416B. Collar 418 is edge rolled after assembly of the other components of the sensor.

Diaphragm assembly 420, which provides a generally fluid tight seal between upper and lower housing portions 412 and 414 and which therefore effectively defines upper and lower pressure chambers 413 and 415, includes a diaphragm 422, a retaining ring 424, and a magnet carrier pin 426. (‘Generally fluid-tight,’ as used herein, refers to a seal that has a leakage rate low enough to not interfere with effective operation of the diaphragm and the filter-monitoring differential sensor.) Diaphragm assembly 420 is also shown in perspective in FIG. 4E.

Diaphragm 422 includes an annular outer bead 4221 and an inner annular bead 4222, which peripherally bound a convex annular portion 4223. Outer bead 4221 is sandwiched between adjacent annular portions of the upper and lower housing portions 412 and 414, specifically lower rim of upper housing portion 412 and annular ledge 4142B. Inner annular bead 4222 is sandwiched between retaining ring 424 and magnet carrier pin 426, which engage each other via a snap fit. The exemplary embodiment forms diaphragm 422 from silicon, fluorosilicone, or other suitable material.

Retaining ring 424 includes an annular trough 4241 which seats an upper portion of calibration spring 440. Retaining ring 224 also secures and seals the diaphragm against an annular flange portion 4261 of magnet carrier pin 426.

Magnet carrier pin 426 includes, in addition to annular flange portion 4261, an annular wall portion 4262, a plate portion 4263, and a pin portion 4264. Annular wall portion 4262 includes a lower ridge portion 4262A which cooperates with annular flange portion 4261 to facilitate the snap fit with retaining ring 424. Plate portion 4263 is bounded by annular wall portion 4262, and positioned intermediate lower ridge portion 4262A and annular flange portion 4261. Pin portion 4264, which generally defines a right cylinder coaxial with axis 401, extends orthogonally from a central region of plate portion 4263, with its upper portion extending into the guide sleeve. Pin portion 4264 has an substantially uniform outer most diameter that is sized to provide a tightly toleranced fit with the guide sleeve to reduce or minimize its ability to move in response to vibration and transient pressure changes. Additionally, pin portion 4264 includes outer ribs, grooves, or coarse texturing (not visible in the Figure), to ensure pressure equalization between upper chamber 413 and the space between the end of pin portion 4264 and the top of the guide sleeve. Pin portion 4264 also includes a cylindrical recess 4264A for carrying magnet 430.

Magnet 430, which is heat staked or epoxied into recess 4264A, includes respective north and south poles 431 and 432. The north pole is shown oriented toward the low pressure port. In the exemplary embodiment, magnet 430 takes a right cylindrical form with a beveled edge on one end to denote the north pole. The magnet is also positioned substantially coaxially with axis 401 and with its physical or magnetic midpoint in alignment with Hall-effect sensor 4123A. One suitable type of magnet is samarium cobalt.

Calibration spring 440, which in the exemplary embodiment is formed of stainless steel, has an upper end 441 seated within annular trough 4241 and a lower end 442 fitted around the sidewall of negative pressure port. The spring can be selected to calibrate operation of the differential sensor.

When operated as intended, the high and low pressure ports of the differential sensor are coupled across a filter. As the filter operates, a differential pressure develops between the low and high pressure ports, eventually exceeding the bias force of the calibration spring and causing the diaphragm assembly to move the magnet axially within the confines of the guide sleeve. The hall-effect sensor is sufficiently close to the magnet to change an electrical parameter, such as voltage or current that is communicated through sensor-connector module. Customer circuitry coupled to the connector interprets the output signal as indicating a clogged or unclogged filter condition.

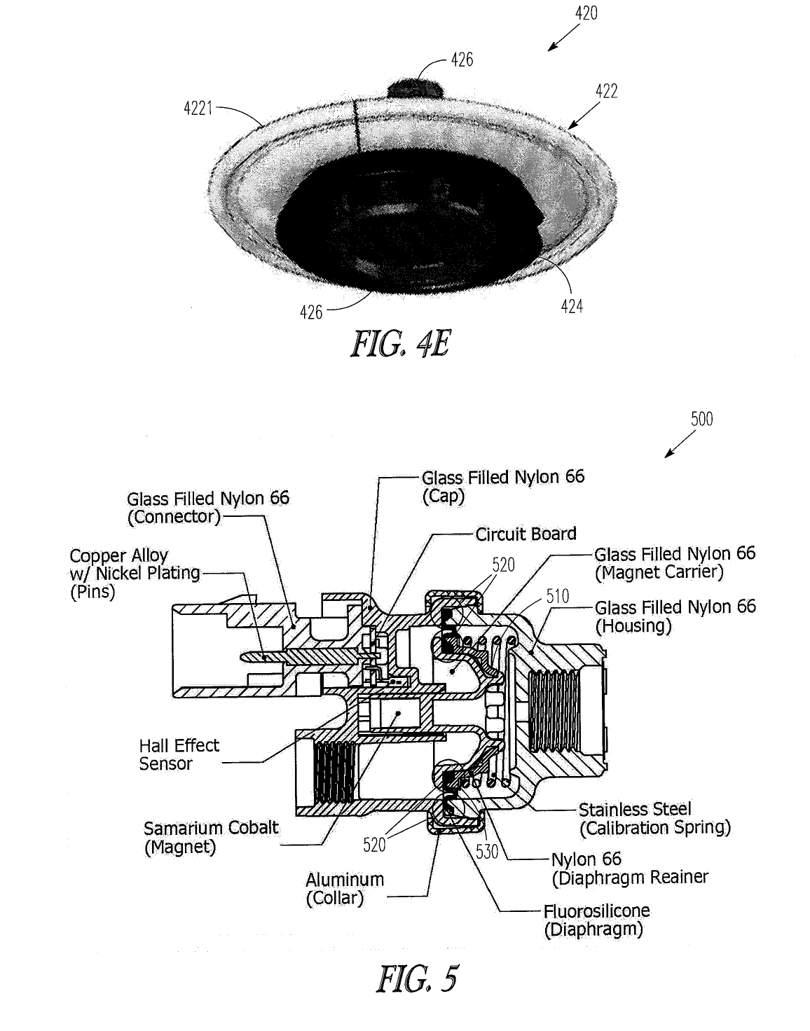

FIG. 5 shows an alternative differential sensor 500, which is generally functionally and structurally similar to differential sensor 100 (400) described above. Notably, sensor 500 includes enhancements to accommodate higher differential pressures. In addition to being generally more compact in terms of cylindrical space requirements of 4.77 cubic inches (based on max. sensor radius of 0.75 in. and max length of 2.70 inches.), sensor 600 includes a thicker diaphragm 510 to avoid pressure induced breach, triangularized bead seals 520 to improve seal retention under pressure, and a retention ring 530 on the magnet carrier pin to assists in retaining the inner bead of the diaphragm.

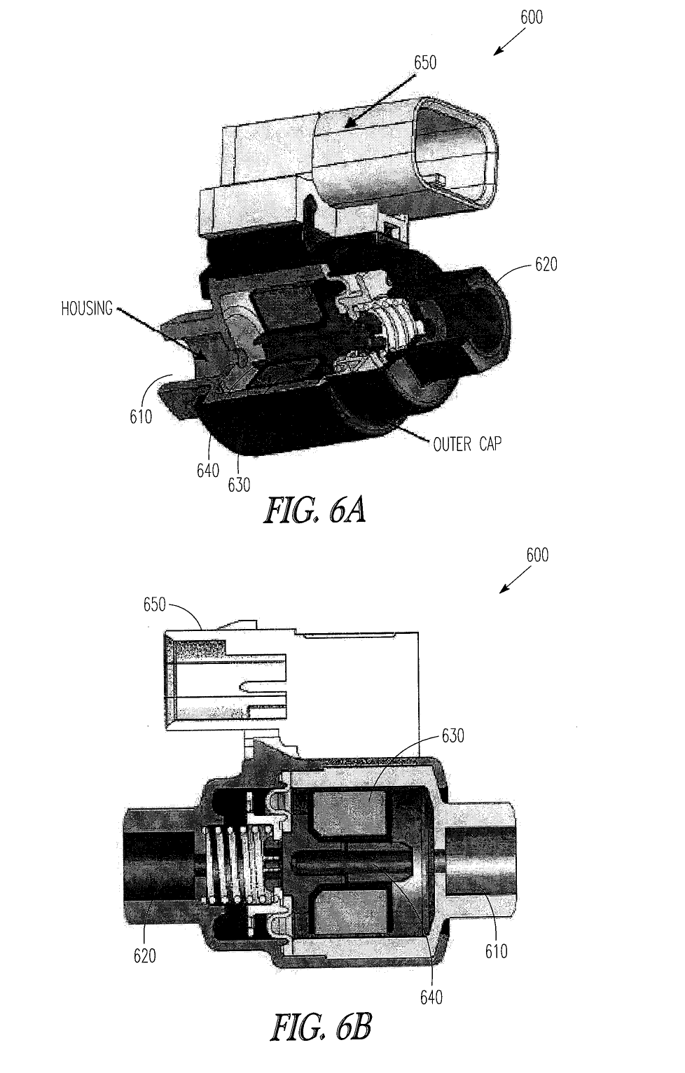

FIGS. 6A and 6B shows another alternative differential sensor 600, which also functions similar to differential sensor 100 (400). However, there are several major structural differences. First, sensor 600 arranges the high and low pressure inlets 610 and 620 such that they are coaxial rather than axially offset as are their counterparts in sensors 100 and 500. Secondly, sensor 600 provides an annular magnet 630 which encircles a magnet carrier pin 640. And thirdly, a connector-sensor module 650 is mounted in a piggy-back configuration on the housing assembly, rather than being integrated as in the sensors 100 and 500.

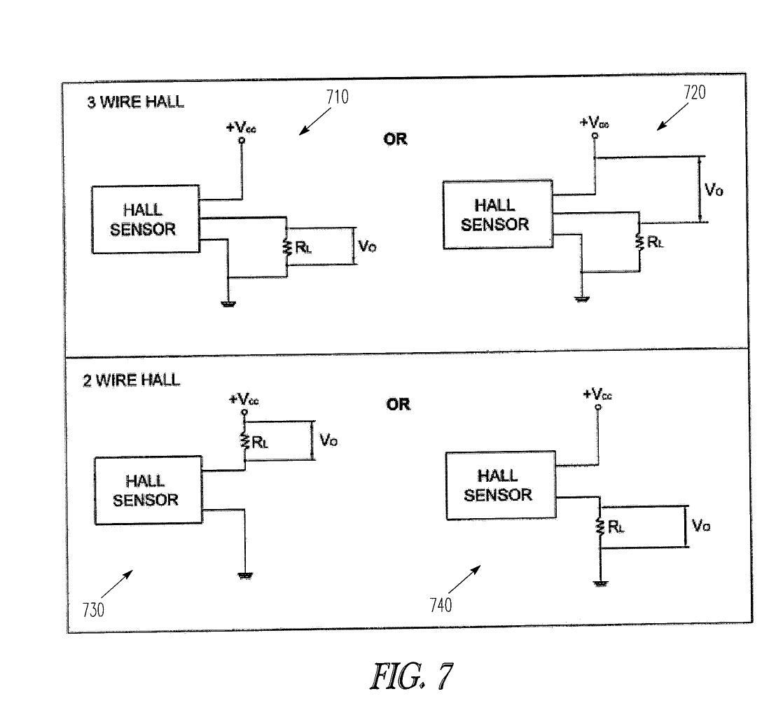

In FIG. 7, sensor wiring schematics 710, 720, 730, and 740 show how the Hall-effect sensors of any of the sensors described herein can be electrically coupled to operate in two- or three-wire configurations. In the two-wire configurations, the sensors operate such that the magnet travel reaches a specific limit, the current out of the sensor switches from one non-zero level to another, rather than switching from a zero current to a non-zero current. The two-wire configurations are advantageous because the first non-zero current levels enables a vehicle computer to readily determine the operating status of the sensor using only two wires as opposed to three. Also, if the first non-zero current level deviates from a predetermined range, the sensor may be deemed faulty and in need of replacement. In the three-wire configurations, the sensors output a variable output current or voltage as the magnet travels in unison with the diaphragm assembly.

Exemplary electrical characteristics of the hall-effect sensors for the two- and three-wire configurations in FIG. 7 are shown respectively in Tables 2 and 3 below.

TABLE 2
Exemplary-2 Wire Hall Sensor Specifications

| | | | |
|---|---|---|---|
| Min | Typ | Max | Units |

MAXIMUM RATINGS

| | | | | |
|---|---|---|---|---|
| Operating Voltage | 3.5 | 12 | 24 | V |
| Current (low) | 5 | 6 | 6.9 | mA |
| Current (high) | 12 | 15 | 17 | mA |
| Overvoltage Protection | — | — | 28 | V |
| Reverse Voltage | −18 | — | — | V |
| Operating Temperature | −40 | — | 150 | ° C. |

OPERATING CHARACTERISTICS

| | | | | |
|---|---|---|---|---|
| Operating Voltage | 5 | 12 | 12 | V |
| EMI Series Resistor | 30 | 30 | 30 | Ω |
| Max Load Resistor | 25 | 450 | 100 | Ω |
| Vₒₗ Min | 0.125 | 2.25 | 0.5 | V |
| Vₒₗ Max | 0.173 | 3.105 | 0.69 | V |
| Vₒₕ Min | 0.3 | 5.4 | 1.2 | V |
| Vₒₕ Max | 0.425 | 7.65 | 1.7 | V |
| ΔV Min | 0.128 | 2.295 | 0.51 | V |
| ΔV Max | 0.3 | 5.4 | 1.2 | V |

TABLE 3
Exemplary 3-Wire Hall Sensor Specifications

| | | | |
|---|---|---|---|
| Min | Typ | Max | Units |

MAXIMUM RATINGS

| | | | | |
|---|---|---|---|---|
| Operating Voltage | 4.5 | 5 | 5.5 | V |
| Supply Current | — | 5.6 | 8 | mA |
| Overvoltage Protection | — | — | 8 | V |
| Reverse Voltage | −0.1 | — | — | V |
| Operating Temperature | −40 | — | 150 | ° C. |

OPERATING CHARACTERISTICS

| | | | | |
|---|---|---|---|---|
| Output Resistance | — | 1.5 | 3 | Ω |
| Output Load Resistance | 4.7 | — | — | kΩ |
| Output Load Capacitance | — | — | 10 | nF |

### CONCLUSION

The embodiments described above are intended only to illustrate and teach one or more ways of practicing or implementing the present invention, not to restrict its breadth or scope. The actual scope of the invention, which embraces all ways of practicing or implementing the teachings of the invention, is defined only by the issued claims and their equivalents.

What is claimed is:

1. A snap-together differential pressure sensor which can be operated in any physical orientation, the sensor comprising:
a snap-together housing having first and second ports for fluid connection to inlet and outlet ports of a filter, with the housing defining an interior chamber;
a diaphragm positioned within the chamber to define first and second separate pressure chambers in respective fluid communication with the first and second ports;
a magnet within the interior chamber and coupled to move in response to movement of the diaphragm; and
a sensor outside the interior chamber and sufficiently proximate the magnet to exhibit an electrical property change in response to movement of the magnet.

2. The sensor of claim 1, wherein the sensor is a Hall-effect sensor.

3. The sensor of claim 1, wherein the hall-effect sensor is configured to provide a first non-zero current output in response to movement of the diaphragm that is less than a predetermined amount and second non-zero current output in response to movement exceeding the predetermined amount.

4. The sensor of claim 1, wherein the sensor has a nominal maximum rated differential pressure of at least 50 psi and the sensor occupies a cylindrical volume based on its maximum diameter and maximum length of less than 8 cubic inches.

5. The sensor of claim 1, wherein the first and second ports are axially offset from each other.

6. A snap-together differential pressure sensor adapted to operate in a horizontal, vertical, or diagonal orientation, the sensor comprising:
a snap-together housing assembly including a positive pressure portion and a negative pressure portion that snap together to define an interior chamber, with the negative pressure portion having a negative pressure port for fluid communication with an outlet of the fluid filter and the positive pressure portion having a positive pressure port for fluid communication with an inlet of a fluid filter and further having a central cylindrical chamber parallel to and laterally offset from the positive pressure port;
a diaphragm assembly including a flexible annular diaphragm, a diaphragm retaining member, and a magnet carrier pin, with the diaphragm having a peripheral edge portion sandwiched between the positive and negative pressure portions of the snap-together housing to divide the interior chamber of the housing assembly into first and second chambers and having an interior edge portion sandwiched between an the diaphragm retaining member and a first annular flange portion of the magnet carrier pin, the magnet carrier pin having a cylindrical portion that carries a magnet and slideably engages the cylindrical chamber, with the diaphragm retaining member having a second annular flange portion spaced from the first annular flange to engage an interior annular edge portion of the diaphragm retaining member, the retaining member further including an annular recess opposite the interior edge portion of the diaphragm;
a connector assembly having an insulative structure at least partly enclosing a male or female electrical connector coupled to a hall effect sensor and an insulative structure adapted to fit within a recessed portion of the positive pressure portion of the housing assembly and to position the hall effect sensor proximate a wall defining the cylindrical chamber thereby enabling the hall effect sensor to respond to magnetic flux of the magnet within the chamber; and
a calibration spring having a first end positioned in the annular recess of the diaphragm retaining member and a second end positioned within an annular recess portion of the negative pressure portion of the housing assembly; wherein the diaphragm is responsive to a pressure differential between the positive and negative pressure ports to move the magnet relative the hall effect sensor which when coupled to an appropriate electrical circuit produces a electrical signal indicative of the position of the magnet and the differential pressure.

7. The sensor of claim 6, wherein the magnet includes a samarium cobalt magnet.

8. The sensor of claim 6, further comprising an aluminum collar encircling a snap-fitting between the positive and negative pressure portions of the housing assembly.

9. A method of operating a differential pressure sensor, the method comprising:
outputting a current at a first non-zero current level from the sensor in response to a differential pressure being less than a threshold differential pressure; and
changing the current to a second non-zero current level in response to the differential pressure exceeding the threshold differential pressure.

10. The method of claim 9, further comprising providing, in response to the change in the current to the second non-zero current level, a filter-status indication for a filter in fluid communication with the sensor.

11. The method of claim 9, wherein providing the filter-status indication includes illuminating a light in a vehicle that includes the filter.

12. A method of assembly a differential-pressure-type filter monitoring sensor, the method comprising:
snap-fitting a first annular portion of a flexible diaphragm between a retaining ring and a magnet support structure;
placing a calibration spring between a portion of the retaining ring opposite the first annular portion of the diaphragm and a first housing portion having a first port;
sandwiching a second annular portion of the flexible diaphragm between an outer annular portion of the first housing portion and an outer annular portion of a second housing portion, with the second housing portion having a second port axially offset from the first port; and
snap-fitting the first and second housing portions together, thereby defining a generally fluid-tight seal between the first and second ports.

13. The method of claim 12, wherein the first housing portion includes a magnetic sensor electrically coupled to two or more connector pins.

14. The method of claim 13, wherein the magnetic sensor and connector pins are part of a separate module inserted into a socket portion of the first housing portion.

15. The method of claim 12, wherein the magnet support structure includes an annular wall surrounding a central plate region, with the central plate region having a central pin projecting generally orthogonally from the central plate region

16. The method of claim 12, further comprising mounting a collar around a snap-fit joint between the first and second housing portions.

17. A differential pressure type filter-monitoring sensor occupying a cylindrical volume less than 8 cubic inches as defined a maximum diameter of the sensor and its maximum length, wherein the sensor is nominally rated for at least 50 psi and an operating temperature range of −40 to 120 degrees Celsius.

18. The differential pressure type filter-monitoring sensor of claim 17, wherein the sensor requires no adjustment after assembly to function properly while also satisfying the nominal pressure and temperature range ratings.
